(19) United States
(12) Patent Application Publication
(10) Pub. No.: US 2011/0198492 A1
(43) Pub. Date: Aug. 18, 2011

(54) Detection and Quantitation of Pain Medications in Oral Fluid Specimens

(76) Inventor: David L. Black, Nashville, TN (US)

(21) Appl. No.: 13/030,416

(22) Filed: Feb. 18, 2011

Related U.S. Application Data
(60) Provisional application No. 61/305,849, filed on Feb. 18, 2010.

(51) Int. Cl. H01J 49/26

(52) U.S. Cl. 250/282

(57) ABSTRACT

A method for the detection and quantitation of pain medication in oral fluid specimens is provided. First, a Solid Phase Extraction (“SPE”) process is used to isolate cocaine and its metabolite, amphetamines and/or butalbital from human oral fluid samples. Alternatively, Liquid-Liquid Extraction (“LLE”) is used to isolate methadone and its metabolite, fentanyl and norfentanyl, buprenorphine and norbuprenorphine, propoxyphene and norpropoxyphene, carisoprodol, meprobamate, a series of benzodiazepines, tramadol and its metabolites, the analgesic opioids, and tetrahydrocannabinol (“THC”) and its carboxylated metabolite (“THC-C”). Finally, following isolation of these drugs and their metabolites, they are separated respectively using a high performance liquid chromatographic column and a novel combination chromatographic solvents and gradients. All analytes are detected and quantified using a tandem mass spectrometry (“MS/MS”) precursor to produce ion transitions.

### CROSS-REFERENCE TO RELATED PATENTS

The present application claims the benefit of prior U.S. Provisional Application No. 61/305,849, filed Feb. 18, 2010.

### FIELD OF THE INVENTION

The present invention relates generally to detection and quantitation of pain medications in oral fluid specimens, and in a particular though non-limiting embodiment to a plurality of extraction schemes comprising evaluation of chromatographic conditions to detect and quantify a series of drugs and drug metabolites relevant to pain management therapies.

### BACKGROUND OF THE INVENTION

Millions of Americans suffer from chronic to severe pain requiring treatment with opioid and other potentially impairing and addicting drugs. Currently, clinicians rely on drug tests to ensure that their patients are compliant with the prescribed drug therapies, do not divert their medications, and do not take drugs that have not been prescribed.

Traditionally, pain management programs have used urine as the tested specimen, though such methods have been found inferior to oral fluid analyses for many reasons. For example, only drug metabolites (rather than the actual parent drugs) are commonly found in urine. In contrast, oral fluid often contains higher concentrations of parent drugs rather than the metabolite. However, oral fluid collection volumes are typically 1.0 mL or less, while that of urine collection may exceed 100 mL. Because of the limited volumes of oral fluid samples, an integrated testing regiment is required for the comprehensive analysis of oral fluids for pain management.

Despite the additional efforts required in association with oral fluid specimen analysis, the present inventors have found that oral fluid testing has several advantages over urine testing, including (but not limited to) the following: specimen collections can be directly observed; no special facilities are required for the collection sites; and, oftentimes, parent drugs are detected.

However, oral fluid collection volumes are typically less than 1.0 mL, and, even when diluted with stabilizing collection buffers, often do not exceed 4.0 mL of total volume. Because of the limited volume and number of drugs that may be prescribed for control of chronic pain, an integrated testing process is needed to ensure comprehensive testing of oral fluid in support of pain management therapies. Similarly, there is a need for an integrated testing process useful for detecting and quantifying the presence of illicit drugs, as well as other, legal drugs that might also be abused.

### SUMMARY OF THE INVENTION

The invention described herein therefore overcomes the problems of the prior art by combining a plurality of simple, yet comprehensive, extraction schemes with a set of simple chromatographic conditions to detect and quantify a series of drugs and drug metabolites relevant to pain management therapies.

A method of detecting and quantifying the presence of a series of drugs and drug metabolites relevant to pain management therapies is provided, comprising at least the following steps: obtaining an oral fluid specimen from a patient, said specimen comprising native constituents and compounds of interest; isolating said compounds of interest from said native constituents by Solid Phase Extraction and/or Liquid-Liquid Extraction; separating said compounds of interest using a high performance liquid chromatographic (“HPLC”) column and a combination of chromatographic solvents and gradients; and detecting and quantifying said compounds of interest using a tandem mass spectrometry precursor to produce measurable ion transitions.

### BRIEF DESCRIPTION OF DRAWINGS

The embodiments disclosed herein will be better understood, and numerous objects, features, and advantages made apparent to those skilled in the art by referencing the accompanying drawings.

FIG. 1 illustrates an HPLC gradient program consistent with an example embodiment, designed to detect and quantify amphetamines, butalbital, cocaine, and their metabolites in a given oral fluid specimen.

FIGS. 2A & 2B illustrates an HPLC gradient program consistent with an example embodiment, designed to detect and quantify benzodiazepines, oxazepam, buprenorphine, carisoprodol, fentanyl, methadone, opiates, oxycodone, oxymorphone, propoxyphene, tramadol, THC, and their metabolites in a given oral fluid specimen.

FIGS. 3A & 3B illustrates the conditions and specifications for a SPE process consistent with an example embodiment.

FIG. 4 illustrates the conditions and specifications for an LLE process consistent with an example embodiment.

### DETAILED DESCRIPTION OF SEVERAL EXAMPLE EMBODIMENTS

According to one specific though non-limitative embodiment, the present invention comprises one or more of the following steps:

First, a Solid Phase Extraction (hereinafter “SPE”) process is used to isolate cocaine and its metabolite (benzoylecgonine), as well as amphetamines such as methamphetamine, methylenedioxymethamphetamine (“MDMA”), methylenedioxyamphetamine (“MDA”), methylenedioxyethylamine (“MDEA”), and/or butalbital from human oral fluid samples.

Next, Liquid-Liquid Extraction (hereinafter “LLE”) is used to isolate methadone and its metabolite (“EDDP”), fentanyl and norfentanyl, buprenorphine and norbuprenorphine, propoxyphene and norpropoxyphene, carisoprodol, meprobamate, a series of benzodiazepines (alprazolam, diazepam, nordiazepam, oxazepam, temazepam, flurazepam, clonazepam, and lorazepam), tramadol and its metabolites (o-desmethyltramadol and n-desmethyltramadol), the analgesic opioids (such as codeine and its metabolite norcodeine, dihydrocodeine, morphine, hydromorphone and oxymorphone, hydrocodone and norhydrocodone, and oxycodone and its metabolite noroxycodone). In the second LLE, tetrahydrocannabinol (“THC”) and its carboxylated metabolite (“THC-C”) are isolated.

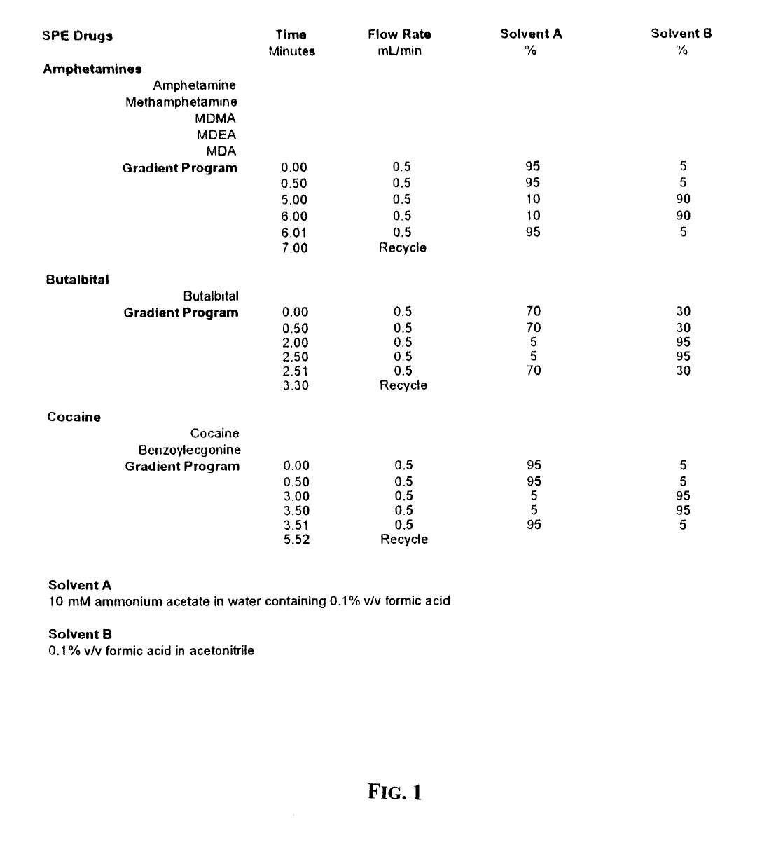

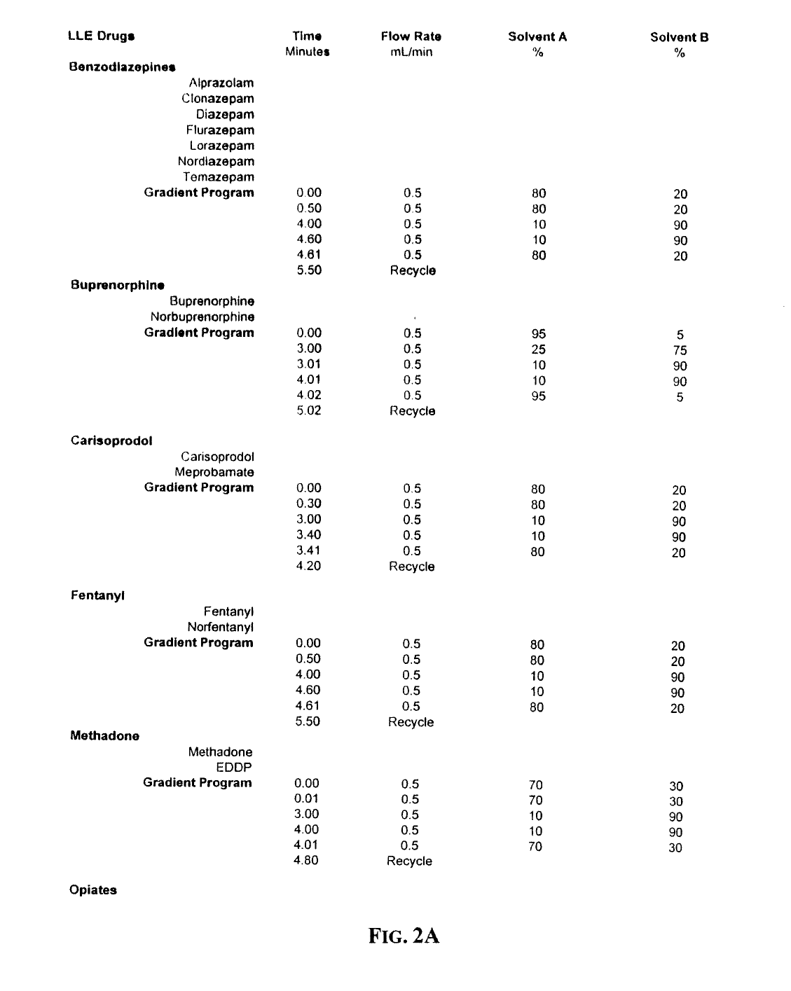

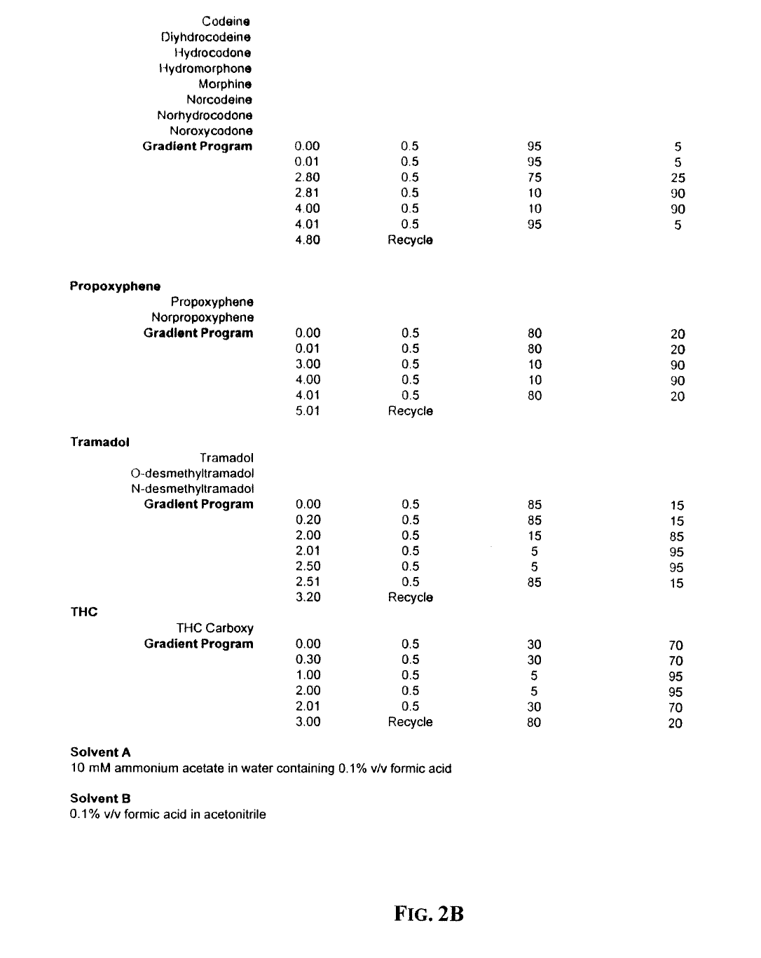

Finally, following isolation of these drugs and their metabolites, they are separated respectively using a HPLC column and a novel combination of chromatographic solvents and gradients (See, for example, FIGS. 1, 2A & 2B). All analytes are detected and quantified using tandem mass spectrometry (“MS/MS”) precursor to produce ion transitions.

Although those of skill in the pertinent arts will readily appreciate that analysis of biological fluids can often be problematic because of interfering compounds that may be inherent in the specimen(s) or introduced during collection, the process described above achieves an analytical schema in which no interferants are encountered from the collection protocol or the resulting oral fluid specimens.

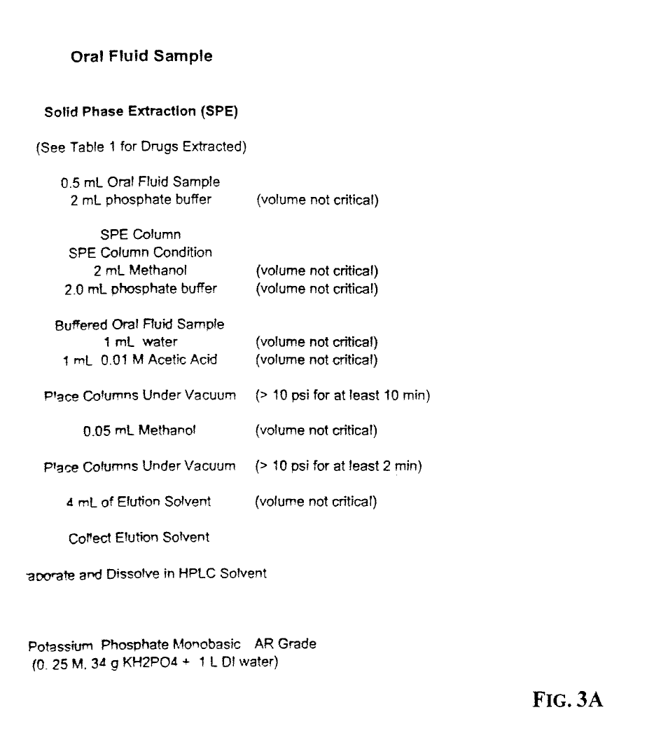

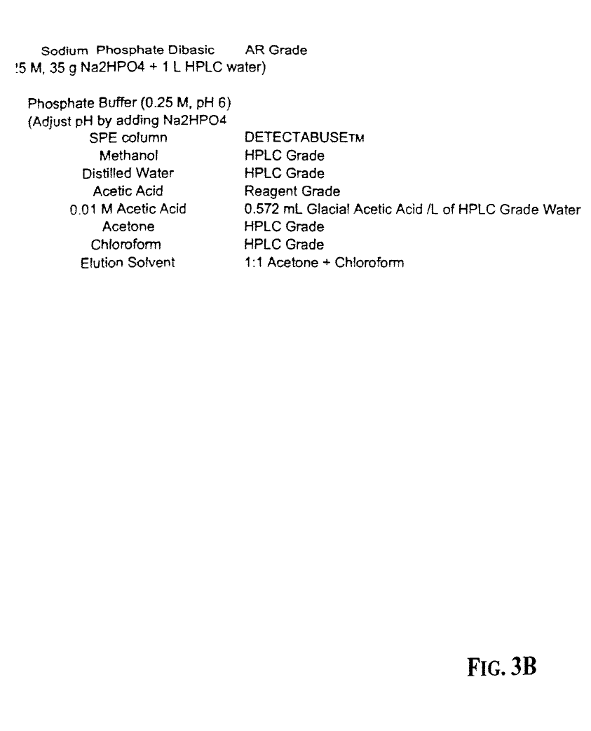

In one example embodiment, SPE columns are used to selectively extract (or isolate) cocaine and its metabolite, amphetamines (amphetamine, methamphetamine, MDMA, MDA, MDEA) and butalbital from a total volume of 0.5 mL of oral fluid. When combined with the selectivity of the HPLC and the solvents and gradients shown in FIG. 1, the entire process results in the unique identification and quantitation of these drugs. FIGS. 3A & 3B further illustrate exemplary conditions and specifications for a SPE process consistent with a specific though non-limitative embodiment.

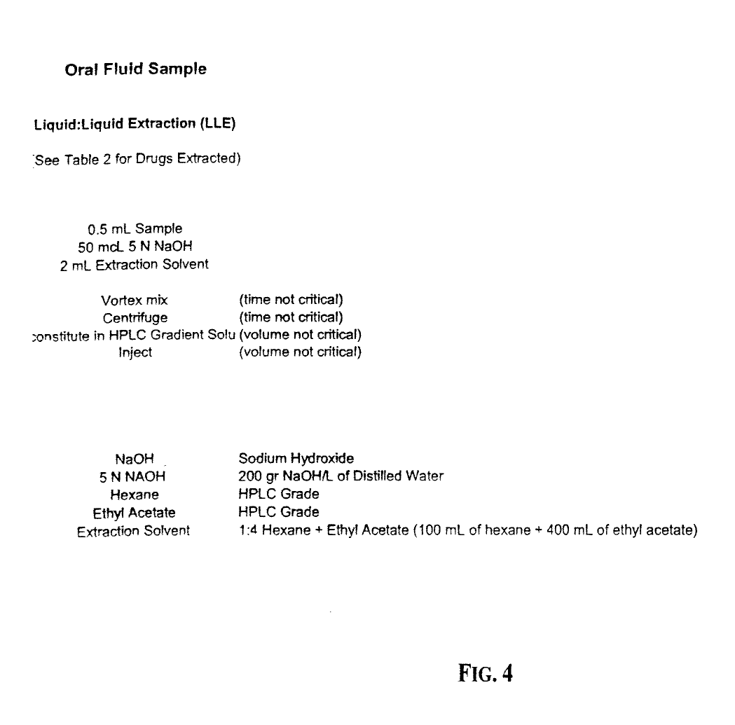

Similarly, the LLE process achieves selective extraction of methadone, fentanyl, buprenorphine, propoxyphene, tramadol, and their metabolites, carisoprodol, meprobamate, benzodiazepines (such as alprazolam, diazepam, nordiazepam, oxazepam, temazepam, flurazepam, clonazepam, and lorazepam), and common opioids (such as codeine and its metabolite norcodeine, dihydrocodeine, morphine, hydromorphone and oxymorphone, hydrocodone and norhydrocodone, and oxycodone and its metabolite noroxycodone) from a specimen comprising approximately 0.5 mL of oral fluid. FIG. 4 further illustrates exemplary conditions and specifications of an LLE process consistent with a specific though non-limitative embodiment.

A third specimen comprising approximately 0.5 mL aliquot of oral fluid is used for the extraction of THC and its metabolite. By the combined efficiency of the LLE extraction methods and the HPLC solvent and gradients developed, the drugs and metabolites discussed above (FIGS. 2A & 2B) are uniquely identified and quantified.

Previously, SPE and LLE have been used to extract drugs and their metabolites from biological matrices in preparation for instrumental analysis. SPE columns using a variety of extraction materials are commercially available, or they can be prepared by a laboratory. Similarly, a review of the scientific literature will demonstrate that a multitude of LLE solvents and solvent combinations have previously been published for drug and metabolite extraction from biological matrices.

Similarly, HPLC is a known chromatographic technique. For example, HPLC is now routinely combined with MS/MS for the analysis of drugs and drug metabolites. Computer controlled HPLC-MS/MS instruments are commercially available from several manufacturers. These instruments are typically used by drug analysis laboratories in MS/MS mode to identify and quantify drugs and their metabolites.

Conceptually, “comprehensive” drug screens in which multiple drugs are detected from a single or limited number of extractions are drawn to the same basic subject matter as the invention described herein. However, these procedures are typically performed using blood or urine specimens, and they are not specifically designed to conserve specimen content, provide quantitative results, and/or support pain management therapies.

The novel aspects of this invention, therefore, are the combination of the SPE and LLE extractions and the chromatographic separation conditions for the detection and quantitation of the drugs and metabolites such as those shown in FIGS. 1, 2A & 2B. The protocols conserve the limited specimen volume while allowing the laboratory to test for an extensive list of drugs relevant to pain management. In practice, pain management MS/MS protocols are often applied to the analysis of specimens indentified as potentially positive by immunoassay drug-screen-tests.

A commercially available SPE column is used to isolate the amphetamines, butalbital and cocaine, a unique solvent system (hexane:ethyl acetate−1 part+4 parts v/v) and strongly basic conditions are used in the LLE extraction to isolate the drugs and metabolites shown in FIGS. 2A & 2B. Once the drugs and metabolites are isolated from the oral fluid, they are subjected to HPLC-MS/MS analysis.

By imposing a comprehensive yet elegant set of predetermined conditions, each of the drugs and metabolites can be separated using a single HPLC column and the gradient conditions shown in FIGS. 1, 2A & 2B. Use of a single HPLC column reduces the need to employ multiple HPLC-MS/MS systems in order to analyze a diverse panel of drugs and drug metabolites such as those shown (or the diverse panel of drugs and metabolites shown in FIGS. 2A & 2B).

According to one example embodiment, the novel parts of the invention interact in the following way: the LLE and SPE conditions are optimized to selectively isolate the drugs and their metabolites from other material in the oral fluid that could potentially interfere with the analysis. HPLC solvents and gradient conditions are used to uniquely identify and quantitate the drugs and their metabolites discussed above and shown in FIGS. 1, 2A & 2B.

Although both the extraction and the HPLC conditions have been optimized, it is the combination of the two processes that completes the process. Furthermore, it is the combination of the proper LLE and SPE with the uniquely designed HPLC conditions that result in the sensitivity and specificity of the analyses. The combination of the extraction, separation and HPLC conditions allows for the analysis of a broad and diverse panel of drugs while conserving the limited oral fluid volume.

Certain modifications to the process can be made, however, while still remaining within the scope of the invention. For example, separate extractions and HPLC conditions can be designed to analyze individual components of the drug lists. Independent methods have also been published for the analysis of selected opiates, barbiturates, cocaine, THC and other drugs in oral fluid samples. Such methods can be applied to oral fluid collected by various means such as spitting, drooling and from alternate commercial collection devices. It is also possible to analyze at least some drugs and metabolites listed by alternate analytical techniques such as GC/MS or GC-MS/MS.

That said, test results might be compromised if one of the critical extraction processes is eliminated, or if the HPLC gradient for any of the individual analysis is significantly modified. However, neither minor changes to the specific processes nor elimination of one or more of the drugs and metabolites would constitute a fundamental change in the invention.

Conditions for the drugs and metabolites listed in FIGS. 1, 2A & 2B have been optimized to lend simplicity to the present description. However, the extraction and HPLC conditions would likely accommodate additional drugs and metabolites having chemical and physical properties similar to those presented therein. For example, additional barbiturate drugs could be accommodated in the butalbital analysis without significant complication of the process. It is also possible that the invention could be used to accommodate even smaller volumes of oral fluid than the typical 0.5 mL/extraction. Furthermore, the invention could be used to accommodate other biological matrices, such as sweat for example, that are also available in limited volume.

The foregoing detailed description is intended primarily for illustrative purposes, and is not intended to include all possible aspects of the present invention. Moreover, while the invention has been shown and described with respect to an exemplary embodiment, those of skill in the pertinent arts should appreciate that the foregoing detailed description, and various other modifications, omissions and additions, so long as in the general form and detail thereof, may be made without departing from either the spirit or scope of the present invention.

1. A method of detecting and quantifying the presence of a drug relevant to pain management therapies, said method comprising:
obtaining an oral fluid specimen from a patient, said specimen comprising native constituents and one or more compounds of interest;
detecting and isolating said compounds of interest from said native constituents by means of solid phase extraction;
separating said compounds of interest using a liquid chromatographic column and one or more chromatographic solvents; and
identifying and quantifying said compounds of interest using a tandem mass spectrometry precursor to produce measurable ion transitions.

2. The method of claim 1, wherein separating said compounds of interest further comprises the use of one or more chromatographic gradients.

3. The method of claim 1, wherein said compounds of interest comprise at least one member of the group consisting of cocaine or a metabolite thereof, an amphetamine, and butalbital.

4. The method of claim 1, further comprising the steps of:
using a second portion of the oral fluid specimen from the patient, said second portion comprising expected constituents and detectable compounds;
detecting and then isolating said detectable compounds from said expected constituents by means of liquid-liquid extraction;
separating said detectable compounds using said liquid chromatographic column and a second combination of chromatographic solvents, and
identifying and quantifying said detectable compounds using a tandem mass spectrometry precursor to produce measurable ion transitions.

5. The method of claim 3, wherein said metabolite is benzoylecogonine.

6. The method of claim 4, wherein separating said detectable compounds further comprises a second combination of chromatographic gradients.

7. The method of claim 4, wherein said detectable compounds comprise at least one member selected from the group consisting of: methadone or a methadone metabolite, fentanyl, norfentanyl, buprenorphine, norbuprenorphine, propoxyphene, norpropoxyphene, carisoprodol, meprobamate, a series of benzodiazepines, tramadol or a tramadol metabolite, and analgesic opioids.

8. The method of claim 4, wherein said detectable compounds comprise at least one of tetrahydrocannabinol and a tetrahydrocannabinol metabolite.

9. The method of claim 7, wherein said methadone metabolite further comprises EDDP.

10. The method of claim 7, wherein said series of benzodiazepines further comprises one or more of alprazolam, diazepam, nordiazepam, oxazepam, temazepam, flurazepam, clonazepam and lorazepam.

11. The method of claim 7, wherein said tramadol metabolites further comprise one or more of o-desmethyltramadol and n-desmethyltramadol.

12. The method of claim 7, wherein said analgesic opioid further comprises one or more of codeine, norcodeine, dihydrocodeine, morphine, hydromorphone, oxymorphone, hydrocodone, norhydrocodone, oxycodone and noroxycodone.

13. The method of claim 8, wherein said tetrahydrocannabinol metabolite further comprises THC-C.

14. A method of detecting and quantifying the presence of a drug relevant to a pain management therapy, said method comprising:
obtaining an oral fluid specimen from the patient, said specimen comprising expected constituents and detectable compounds;
detecting and isolating said detectable compounds from said expected constituents by means of liquid-liquid extraction;
separating said detectable compounds using a liquid chromatographic column and a combination of chromatographic solvents; and
identifying and quantifying said detectable compounds using a tandem mass spectrometry precursor to produce measurable ion transitions.

15. The method of claim 14, wherein separating said detectable compounds further comprises using a combination of chromatographic gradients.

16. The method of claim 14, wherein said detectable compounds comprise at least one member selected from the group consisting of: methadone or a methadone metabolite, fentanyl, norfentanyl, buprenorphine, norbuprenorphine, propoxyphene, norpropoxyphene, carisoprodol, meprobamate, a series of benzodiazepines, tramadol or a tramadol metabolite, analgesic opioids, and tetrahydrocannabinol or a tetrahydrocannabinol metabolite.

17. The method of claim 16, wherein said methadone metabolite comprises EDDP.

18. The method of claim 16, wherein said series of benzodiazepines further comprises one or more of alprazolam, diazepam, nordiazepam, oxazepam, temazepam, flurazepam, clonazepam, and lorazepam.

19. The method of claim 16, wherein said tramadol metabolites further comprises one or more of o-desmethyltramadol and n-desmethyltramadol.

20. The method of claim 16, wherein said analgesic opioids further comprises one or more of codeine, norcodeine, dihydrocodeine, morphine, hydromorphone, oxymorphone, hydrocodone, norhydrocodone, oxycodone and noroxycodone.

21. The method of claim 16, wherein said tetrahydrocannabinol metabolite further comprises THC-C.
